(19) United States
(12) Patent Application Publication
(10) Pub. No.: US 2004/0042798 A1
(43) Pub. Date: Mar. 4, 2004

(54) Optical transceiver with a dual-axis tilt mirror for pointing and tracking free space communication signals

(75) Inventors: Robert L. Kehr, Parker, CO (US); Robert T. Carlson, Surrey (CA); George Stephen Mecherle, Hawthorne, CA (US); David Rockwell, Culver City, CA (US); Pablo Bandera, Vancouver (CA); Vladamir Draganov, Coquitlam (CA); Daryl G. James, Vancouver (CA); Derek G. Montgomery, New Westminster (CA)

Correspondence Address: LYON & LYON LLP, 633 WEST FIFTH STREET, SUITE 4700, LOS ANGELES, CA, 90071, US

(73) Assignee: fSONA COMMUNICATIONS CORPORATION

(21) Appl. No.: 10/234,050

(22) Filed: Aug. 29, 2002

(51) Int. Cl. H04B 10/00

(52) U.S. Cl. 398/135; 398/129

(57) ABSTRACT

An optical transceiver comprises a signal transmitter emitting an outgoing communication signal and transmit optics to transmit that includes a transmit telescope. The transceiver additionally comprises receive optics that includes a receive telescope to receive an incoming communication signal and a signal receiver. A dual-axis tilt mirror optically couples the signal transmitter to the transmit optics so that the outgoing communication signal is transmitted by the transmit telescope. The same dual-axis tilt mirror also optically couples the receive optics to the signal receiver so that the incoming communication signal is received by the signal receiver. Thusly configured, the angular orientation of the dual-axis tilt mirror simultaneously controls the reception and transmission orientations of the receive and transmit telescopes, respectively.

### BACKGROUND OF THE INVENTION

1. Field of the Invention

The field of the present invention is wireless communications systems. In particular, the invention is directed to transceivers including pointing and/or tracking systems to maintain the orientation of the transceiver.

2. Background

One of the hurdles faced by any point-to-point free space optical communications system is how to maintain proper alignment between a transmitter and a receiver so that data losses may be avoided during transmission. This problem is additionally complicated by two-way transmissions between free space optical transceivers, because proper alignment between each transmitter and receiver pair is required to maintain two-way communications. Two chief sources of data loss in free space optical communication systems are the loss of line of sight alignment between the transceivers due to disturbances of one or both transceivers and atmospheric scintillation.

Disturbances to a transceiver, such as building motions, wind gusts, and structural vibrations, may cause the transceiver to drift away from the established line of sight alignment with the remote transceiver, even if only momentarily. If the magnitude of the misalignment is such that the transmitted beam substantially misses the remote transceiver, significant data loss may result. At short distances, a limited amount of misalignment may be compensated for by divergence in the transmitted beam. For short range applications with relatively low data rates, a fairly wide beam divergence can usually compensate for most disturbances while still providing adequate signal to the remote transceiver to avoid data loss.

For longer distance and higher data rate applications, smaller beam divergences are typically required to deliver adequate signal to the remote transceiver to avoid data loss. For such applications, variances away from the line of sight alignment can cause significant data loss. To avoid such data loss problems, one or both of the transceivers are directionally steered to maintain line of sight alignment. Different steering methods have been developed to maintain line of sight alignment between the transceivers. In a steering first method, the orientation of the transmitter and receiver portions of the transceiver are fixed relative to each other and the entire transceiver is steered using a pointing and tracking system to maintain line of sight alignment. An example of such a pointing and tracking system is disclosed in U.S. patent application Ser. No. 09/758,689, filed Jan. 10, 2001. However, depending upon the weight and size of the transceiver, steering the entire transceiver may introduce unwanted inefficiencies in particular applications.

In a second steering method, disclosed in U.S. Pat. No. 5,390,040, the orientation of the transmitter and receiver portions of the transceiver are fixed and a steering mirror is disposed in front of both the transmitting and receiving apertures. The steering mirror directs the transmitted and received beams to and from the remote transceiver. The angular position of the steering mirror may be adjusted to compensate for any errors in the line of sight alignment between the transceivers. The steering mirror, because of its location and its function, must have a diameter that is at least as large as the combined diameters of the transmit and receive apertures. Such a large steering mirror may not be appropriate for size limited applications and may increase the overall cost of the transceiver.

As noted previously, atmospheric scintillation is another primary source of data loss in free space optical communications systems. Scintillation is caused by the random fading of signals transmitted through the atmosphere. The effects of scintillation are most noticeable in optical signals traveling free space distances greater than 1 km. It is understood that the atmosphere is not homogeneous, in that the index of refraction of air is not constant due to wind or turbulence. A beam of light transmitted through the atmosphere is subject to these variations in the index of refraction such that the beam may be momentarily deflected from a straight path. With such deflection, an observer of the beam perceives the source to be flickering. Such flickering is highly disruptive to data transmission. The effects of scintillation may be corrected by increasing the size of the apertures of the receiving unit. Higher intensity sources may also be used to mitigate data losses where the sensitivity of the receiver is not correspondingly decreased. Often, however, physical and practical limitations detract from such solutions.

To significantly overcome the effect of scintillation, spatial diversity transmitters have been constructed which employ multiple lasers arranged to produce displaced parallel beams. As these beams diverge, they overlap one another. When properly aligned, a receiver displaced from the transmitter thus receives multiple uncorrelated overlapping beams at the receiver. As it is unlikely that all beams will be simultaneously diverted, the receiver is able to receive uninterrupted data from at least some of the plurality of transmitters. It has been found that the normalized standard deviation of the intensity at the receiver is reduced by the square root of the number of transmitting elements when properly separated. Reference is made to W. M. Bruno, R. Mangual, & R. F. Zampolin, Diode Laser Spacial Diversity Transmitter, pp. 187-194, SPIE vol. 1044, Optomechanical Design of Laser Transmitters and Receivers (1989), the disclosure of which is incorporated herein by reference. One structural application of the very principles presented in the foregoing publication is found in U.S. Pat. No. 5,777,768, the disclosure of which is also incorporated herein by reference.

In order to maintain adequate spatial separation between the multiple optical signals to overcome the effects of scintillation, each optical signal is transmitted with a separate set of transmitting optical elements. In addition to the transmitting optical elements, a transceiver also includes at least one set of receiving optical elements. Thus, the typical transceiver used in long distance free space optics includes at least three, and more typically at least five, sets of transmit and receive optical elements combined. These multiple sets of optical elements necessarily add weight and bulk to the transceiver. A heavier and bulkier transceiver is of particular concern when pointing and tracking systems, such as gimbals, are employed to overcome transceiver disturbances, as the effects of the added weight and bulk may introduce unwanted inefficiencies in the pointing and tracking process by introducing additional inertia into the pointing and tracking system.

### SUMMARY OF THE INVENTION

The present invention is directed to an optical transceiver for free space communications. The transceiver comprises transmit and receive optics that are optically coupled to a signal transmitter and a signal receiver, respectively, by a dual-axis tilt mirror. The signal transmitter emits an outgoing communication signal which the tilt mirror optically relays to the transmit optics, the transmit optics including a transmit telescope to transmit the outgoing communication signal. The receive optics include a receive telescope to receive an incoming communication signal which the tilt mirror optically relays to the signal receiver.

In a first separate aspect of the present invention, spatial separation between the incoming communication signal and the outgoing communication signal is maintained within the transceiver. The interior of the housing is partitioned into first and second sections, with the transmit optics disposed in the first section and the receive optics disposed in the second section. The tilt mirror is partially disposed in each section such that the outgoing communication signal is incident upon a first portion of the tilt mirror and the incoming communication signal is incident upon a second portion of the tilt mirror that does not overlap the first portion.

In a second separate aspect of the present invention, the transmit and receive telescopes are oriented in parallel directions to have line of sight alignment with a remote location and the orientation of each telescope is fixed relative to the orientation of the other. A beam splitter is optically disposed between the tilt mirror and the signal receiver. The beam splitter splits the incoming communication signal so that part of the incoming communication signal is directed to the signal receiver and the other part is directed to an optical position sensor. The position of the incoming communication signal on the optical position sensor is used to determine a line of sight alignment error between the receive telescope and the remote location. The angular orientation of the tilt mirror may thereafter be adjusted to correct the line of sight alignment error. In correcting the line of sight alignment error between the receive telescope and the remote location, the line of sight alignment error between the transmit telescope and the remote location is concurrently corrected by any adjustments to the tilt mirror. Thus, the line of sight alignment between the transceiver and the remote location may be maintained.

In a third separate aspect of the present invention, the signal transmitter comprises multiple laser transmitters. The laser transmitters emit parallel beams to form a composite beam, the composite beam being the outgoing communication signal. Each parallel beam is preferably spatially separated from each of the other parallel beams. The spatially separated parallel beams remain spatially separated when transmitted by the transmit telescope and thus help compensate for atmospheric scintillation during transmission. Additionally, each parallel beam is preferably offset from an optical axis of the composite beam so that little or none of the composite beam is blocked by the central obscuration in the transmit telescope. Optionally, with this configuration each laser transmitter may be optically coupled to an optical fiber such that one end of the optical fiber receives light emitted from the laser and the other end of the optical fiber emits light as one of the parallel beams.

In a fourth separate aspect of the present invention, any of the foregoing aspects may be employed in combination.

Accordingly, it is an object of the present invention to provide an improved optical transceiver for free space communications. Other objects and advantages will appear hereinafter.

### BRIEF DESCRIPTION OF THE DRAWINGS

In the drawings, wherein like reference numerals refer to similar components:

FIG. 1 schematically illustrates an optical transceiver with separate transmit and receive apertures;

FIG. 2 diagrammatically illustrates the transmit optics of the transceiver of FIG. 1;

FIG. 3 diagrammatically illustrates multiple remotely located laser transmitters fiber coupled to the transmit optics of an optical transceiver;

FIG. 4 illustrates an embodiment of a fiber collimator ferrule;

FIG. 5 schematically illustrates an optical transceiver having a single transmit and receive aperture;

FIG. 6 illustrates another embodiment of a fiber collimator ferrule;

FIGS. 7A & 7B illustrate another embodiment of a fiber collimator ferrule; and

FIG. 8 illustrates another embodiment of a fiber collimator ferrule.

### DETAILED DESCRIPTION OF THE PREFERRED EMBODIMENTS

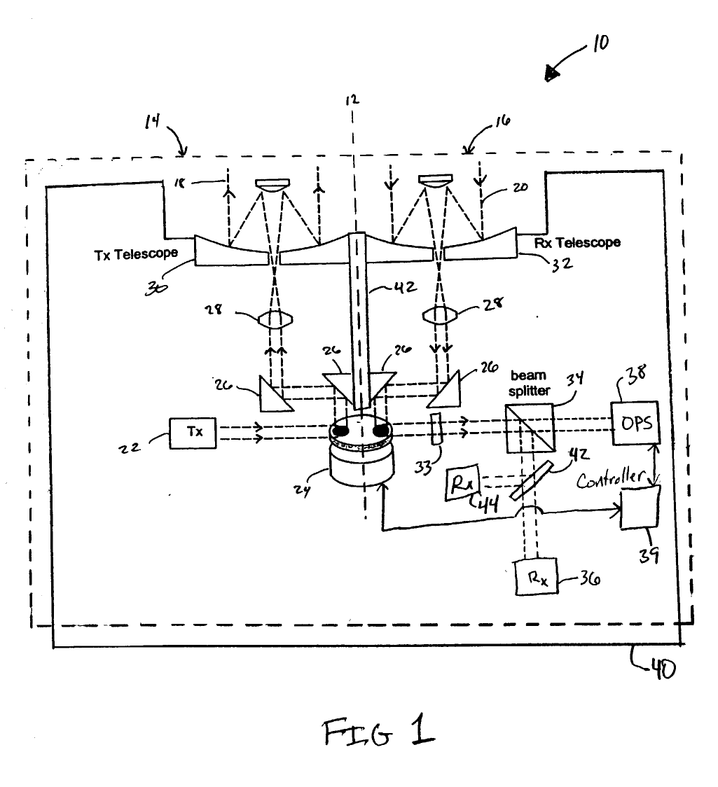

Turning in detail to the drawings, FIG. 1 schematically illustrates a binocular transceiver 10 for free space optical communications. The transceiver is partitioned (the division represented by the line 12) into a transmitting portion 14 and a receiving portion 16 to spatially separate the outgoing and incoming communication signals 18, 20. The optical components of the transmitting portion 14 include a signal transmitter 22, a dual-axis tilt mirror 24, folding mirrors 26, a lens 28, and a transmit telescope 30. The signal transmitter 22 comprises one or more lasers, such as Fabry-Perot lasers or DFB lasers, each coupled to driver circuitry to provide the desired bandwidth in the outgoing signal. For example, the laser and laser driver circuitry described in U.S. patent application Ser. No. 09/769,082, the disclosure of which is incorporated herein by reference, may be used as part of the signal transmitter 22. The transmit telescope 30, lens 28, and folding mirrors 26 form the transmit optics of the transceiver 10. Additional or fewer optical elements may be added to or removed from the transmit optics as desired.

The optical components of the receiving portion 16 include a receive telescope 32, a lens 28, folding mirrors 26, the dual-axis tilt mirror 24, a band-pass filter 33, a beam splitter 34, a signal receiver 36, and an optical position sensor 38. The receive telescope 32, lens 28, and folding mirrors 26 form the receive optics of the transceiver 10. As with the transmit optics, additional or fewer optical elements may be added to or removed from the receive optics as desired. The transmit and receive telescopes 30, 32 illustrated in FIG. 1 are Cassegrain telescopes, although other types of telescopes may be used with the transceiver.

To further spatially separate the outgoing and incoming communication signals, the housing 40 includes a partition 42 that divides the interior of the housing into first and second sections. The partition 42 physically separates the transmit optics from the receive optics. However, because the tilt mirror 24 is used to direct both the incoming and the outgoing communication signals, the partition 42 does not physically divide the entire interior of the housing.

The housing 40 also includes first and second adjacent openings for the transmit and receive telescopes 30, 32, with the transmit telescope 30 disposed in the first opening and the receive telescope 32 disposed in the second opening. The transmit and receive telescopes 30, 32 have fixed orientations with respect to each other and both are oriented to transmit and receive optical signals, respectively, from another transceiver at a remote location.

Within the context of the transceiver, the optical path of the outgoing communication signal 18 starts at the signal transmitter 22, which emits the outgoing communication signal 18 towards the tilt mirror 24. The tilt mirror 24 is optically disposed at the pupil of the transmit telescope 30 to optically relay the outgoing communication signal to the transmit telescope 30. Once the transmit optics receive the outgoing communication signal, the transmit telescope 30 transmits the outgoing communication signal towards the remote transceiver. The optical path of the incoming communication signal 20, within the context of the transceiver 10, starts at the receive telescope 32. The receive telescope 32 receives the incoming communication signal 20 into the receive optics and the receive optics direct the incoming communication signal 20 towards the tilt mirror 24. The tilt mirror 24 is also optically disposed at the pupil of the receive optics to optically relay the incoming communication signal 20 to the beam splitter 34. The beam splitter 34 directs the incoming communication signal to both the signal receiver 36 and the optical position sensor 38.

It should be evident to those skilled in the art that in order to maintain the desired spatial separation between the outgoing and incoming communication signals and to optically couple the signal transmitter to the transmit optics and the receive optics to the beam splitter using the single tilt mirror, the signals necessarily traverse three dimensional optical paths within the transceiver (as compared to the schematic two dimensional optical paths that appear in FIG. 1).

The tilt mirror 24 performs the dual function of optically coupling the signal transmitter 22 to the transmit optics and the signal receiver 36 to the beam splitter 34, receive optics, and optical position sensor 38. The lenses 28 are chosen such that the image magnification of the transmit telescope 30 is substantially the same as the image magnification of the receive telescope 32. With such a configuration, changes to the angular orientation of the tilt mirror 24 have substantially similar effects on the angular orientation of the beams forming the outgoing communication signal and the incoming communication signal. In addition, because the transmit and receive telescopes have orientations that are parallel and fixed relative to each other, the directional orientation of each telescope will track the directional orientation of the other telescope regardless of the changes made to the angular position of the tilt mirror 24. Thus, by adjusting the angular position of the tilt mirror 24, both the incoming and outgoing communication signals are aligned in the same direction and line of sight alignment may be maintained between the transceiver and a second transceiver at a remote location.

By using the single tilt mirror 24 to control the directional orientation of the transmit and receive telescopes, the transceiver has a field of regard that is wide enough to compensate for movement of the structures to which the transceiver is affixed, e.g., buildings, towers, poles, without any need to use a pointing and tracking system that moves the entire transceiver (e.g., a gimbal). The tilt mirror 24, unlike the larger pointing and tracking systems, is small, easily adjustable with a low inertia, and therefore less likely to create mechanical vibrations, such as, for example, reaction torques, that may disturb the optics within the transceiver. Preferably, the tilt mirror 24 is a fine steering mirror, thus enabling fine control over the directional orientation of the transceiver. More preferably, the tilt mirror 24 is a frictionless steering mirror.

The position of the incoming communication signal on the optical position sensor 38 is used to control the angular position of the tilt mirror 24, and thus the directional orientation of the transmit and receive telescopes 30, 32. The outgoing communication signal from each signal transmitter 22 of each transceiver preferably includes a telemetry signal comprised of an electrical subcarrier with Manchester-encoded data that is modulated at an appropriate rate. The modulation rate of the electrical subcarrier determines the upper limit of the rate at which the control loop feeds the tilt mirror controller 39. For example, if the angular position of the tilt mirror is set at 9600 bits per second, then the orientation tilt mirror controller may operate at approximately 1 kHz or more. Having the tilt mirror controller operate at such high rates allows the pointing/tracking system to better respond to disturbances. An additional advantage of the encoded electrical subcarrier is that the encoded data provides a telemetry link between two transceivers which may be used for functions such as network management, automatic power control, and health and status communications between the transceivers. Such a telemetry link is especially useful because it does not use the bandwidth of the primary communication bitstream in the outgoing communication signal.

The optical position sensor 38 may comprise a quad cell, a focal plane array, or any other similar device capable of determining the angular position of an incident light beam. When the transceiver is initially placed for use, the tilt mirror 24 is set at a default position and the transceiver is oriented so that the transmit and receive telescopes have line of sight alignment with a remote transceiver. The default position of the tilt mirror 24 is preferably an angular position that is approximately in the middle of the full range of motion of the tilt mirror 24. Once the transceiver is appropriately aligned, the spot position of the incoming communication signal on the optical position sensor 38 is set as the reference position which provides line of sight alignment between the transceivers.

The signal receiver 36 may comprise any type of photo detector known to those skilled in the art which is capable of resolving the communications signal at the rate transmitted by the signal transmitter. Such photo detectors include, but are not limited to, PIN or APD photo detectors, fiber coupled detectors, and photo detectors having an optically integrated immersion lens.

During operation, the spot position of the incoming communication signal on the optical position sensor 38 is monitored for deviations from the reference position. Deviations in the spot position are measured by the optical position sensor 38 as errors in the line of sight alignment. A measured error in the line of sight alignment is transmitted as an electronic signal to the tilt mirror controller 39. The tilt mirror controller 39 determines, based upon the measured error, whether the angular position of the tilt mirror 24 requires adjustment and how much of an adjustment is required to restore the spot position on the optical position sensor 38 to the reference position. The tilt mirror controller 39 thereafter provides a signal to the tilt mirror 24 to make the adjustment. This process is repeatedly performed to form an active-feed back control loop between the optical position sensor 38, the tilt mirror controller 39, and the tilt mirror 24, thus allowing the transceiver 10 to actively track the position of the remote transceiver and maintain line of sight alignment with the remote transceiver.

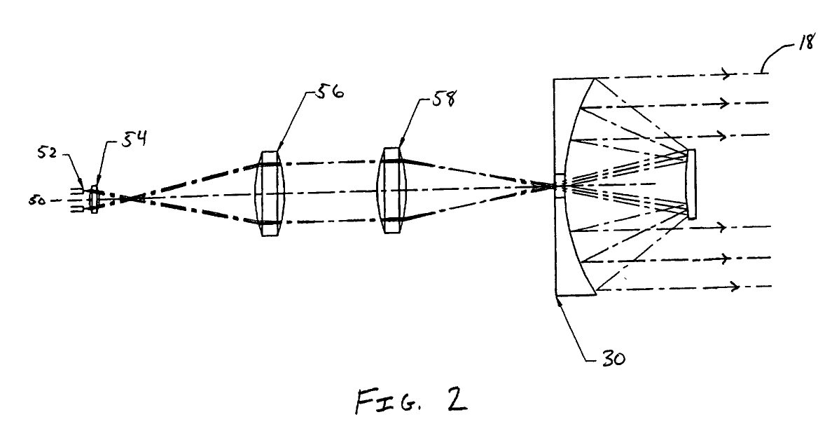

FIG. 2 illustrates the preferred configuration of the outgoing communication signal from the optical transceiver of FIG. 1. Only the transmitting portion of the transceiver is shown in FIG. 2, and for illustration purposes, a simplified version of the transmitting portion is shown which does not include the tilt mirror and the folding mirrors. The outgoing communication signal 18 from the transceiver is a composite beam comprised of multiple spatially separated parallel beams. The optical axis of each parallel beam is displaced a fixed distance from the optical axis of the composite beam. Two parallel beams are shown in FIG. 2 emerging from optical fibers 52, each optical fiber receiving light emitted from separate laser transmitters (not shown in FIG. 2). The optical fibers 52 are preferably single mode fibers, however, multi-mode fibers may also be used. The ends of the fibers from which the parallel beams emerge are disposed in the focal plane of the lens 54 which together with lens 56 form a telecentric reimaging lens pair. The fiber image emerging from lens 56 is directed towards another lens 58 which forms a telecentric reimaging system in combination with the transmit telescope 30. The outgoing communication signal emerges from the transmit telescope 30. The transmit telescope 30 depicted in FIG. 2 is a Cassegrain telescope, although other types of telescopes may be used.

When the outgoing communication signal is formed of a plurality of parallel beams, the aforementioned telemetry signal is preferably encoded into each parallel beam. By having each parallel beam carry the telemetry signal, so long as at least one of the parallel beams is active, a local transceiver retains the ability to track the position of a remote transceiver.

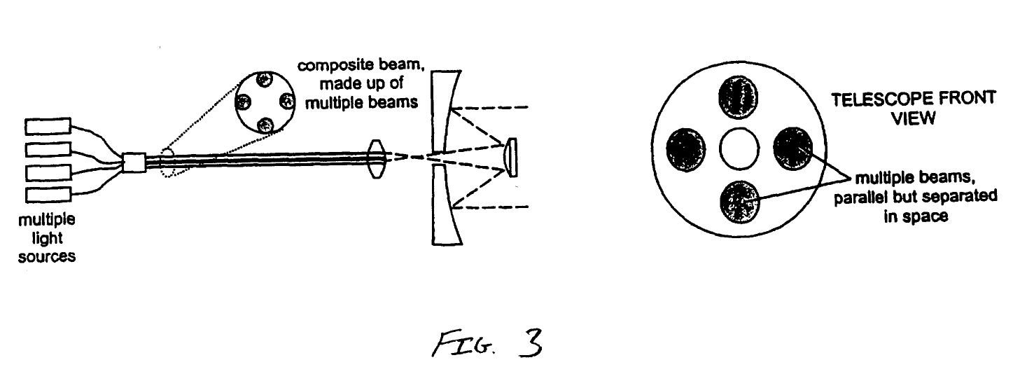

In a preferred embodiment of the transceiver, the multiple laser transmitters are disposed outside the housing that encloses the transmit and receive optics so that heat and electromagnetic interference (EMI) generated by the laser transmitters and any associated electronics are removed from the immediate vicinity of the transceiver optics. The remote laser transmitters may additionally be placed within a shielded housing to further reduce the effects of heat and EMI on the optics of the transceiver. As shown in FIG. 3, the remotely located laser transmitters are fiber coupled to the transmit optics (the transmit optics shown in FIG. 3 are also simplified for illustration purposes).

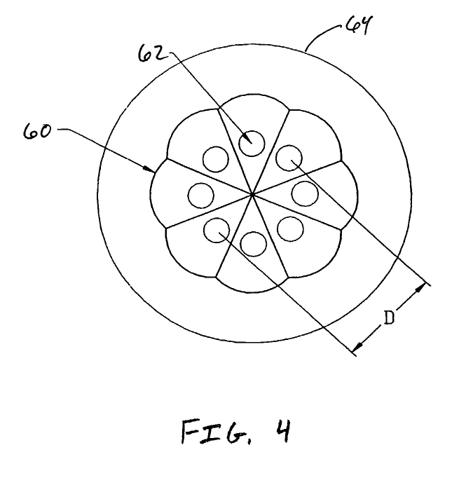

The ends of the fibers within the transceiver from which the parallel beams emerge may be advantageously bundled using the ferrule 60 shown in FIG. 4. The end of each fiber is secured within a wedge-shaped ferrule 60 with the planar core 62 of the fiber exposed to allow the beam to emerge from the fiber. Preferably, the end of the fiber core 62 is planar and lies within the plane formed by one side of the ferrule 60. In FIG. 4, eight fibers having identically shaped ferrules are bundled together, with the distance, D, between any two opposing fiber cores being constant. The bundle may be held together by a rigid or flexible band 64, or by any other appropriate means. Eight parallel beams emerge from the fiber bundle to form the composite beam, with each parallel beam displaced by the same fixed distance from the optical axis of the composite beam. More or fewer fibers may be bundled together, depending upon the wedge size of the ferrule. Alternatively, blank wedges, or wedges to which fibers are not secured, may be placed in the bundle as space holders. Such a bundle typically may include up to a maximum number of fibers. Fewer than the maximum number of fibers may be used by the inclusion of blank wedges.

Several advantages are realized by using a composite beam as the outgoing communication signal of the transceiver. One advantage is that all of the parallel beams forming the composite beam may be effectively treated as a single beam. Each parallel beam is guided by the same optical elements and any variations in the optical system, such as those due to temperature or other environmental factors, should have the same effect on all the parallel beams so that the relative alignment of the parallel beams is not altered prior to transmission. Another advantage is that the relative distance between the parallel beams is expanded as the composite beam passes through the transmit telescope. With the increased distance between the parallel beams, the transceiver is effectively a spatially diverse transmitter with multiple divergent beams that may be used to compensate for the effects of atmospheric scintillation.

Another advantage of the composite beam arises because the parallel beams are offset from the optical axis of the composite beam. A composite beam comprising four parallel beams is illustrated in FIG. 3. During normal use, the optical axis of the composite beam coincides with the central obscuration of the Cassegrain telescope. However, because no light travels along the optical axis of the composite beam, the central obscuration of the Cassegrain telescope will not block and reduce the power of the outgoing communication signal.

Another advantage of the using a composite beam is the ease with which the output power of the transceiver may be modified. The output power of the transceiver may be increased by inserting additional fiber coupled laser transmitters into the transmit system. When a laser transmitter is added to the transmit system, the power in the composite beam is increased by the power of the additional beam. Conversely, the output power of the transmit system may be decreased by removing one or more of the existing fiber coupled laser transmitters. Addition or removal of a fiber coupled laser transmitter is easily accomplished when the laser transmitters are disposed in a separate housing from the transmit and receive optics. Separately housed laser transmitters may be added or removed from the transceiver without risk of disturbing the optics, thus avoiding the need to realign the transceiver. Separately housed laser transmitters also provide a level of modularity to the transceiver that has not previously been available in free space optical communication systems.

Another advantage of the composite beam is that it is capable of providing a significant level of redundancy in the outgoing communication signal. The redundancy helps protect against data loss during transmission. Redundancy is helpful when, for example, one of the laser transmitters stops functioning or when the power of the outgoing communication signal received by the remote transceiver is reduced by poor weather conditions, high wind, or other environmental interference.

Yet another advantage of the composite beam is realized when multiple parallel beams having different wavelengths form the composite beam. The composite beam would thus be formed from a plurality of parallel beams, each of the plurality of parallel beams having a wavelength that is different from the wavelength of each of the other parallel beams. Preferably the multiple parallel beams are paired so that two of the parallel beams having a first wavelength, another two having a second wavelength different from the first. Two parallel beams are included at each wavelength to preserve redundancy and help overcome the effects of atmospheric scintillation. By way of example, the composite beam may include a first pair of parallel beams having a wavelength of 1550 nanometers and a second pair of parallel beams having a wavelength of 1530 nanometers. Additional pairs of parallel beams may be added to the composite beam as desired, each additional pair having different wavelengths from the pairs that presently form the composite beam.

With the composite beam formed of multiple parallel beams at differing wavelengths, the data communication capacity of the transceiver may be increased by multiple factors, limited only in the number of wavelength channels in a particular implementation. In order to utilize the full capacity of such a composite beam and avoid data loss, the signal transmitted via a first parallel beam or parallel beams at a first wavelength must be separable from the signal transmitted by a second parallel beam or beams at a different wavelength. The ease of which differentiating between the multiple wavelengths, and thus the multiple signals, included in the transmitted composite beam is dependent upon several factors.

One factor to consider is the relative closeness of the wavelengths employed. For example, under certain conditions, employing wavelengths separated by approximately 20 nanometers may be sufficient, while under other conditions, greater spacing might be required or lesser spacing might suffice. Another factor is the spectral width of the beams that form the transmitted composite signal. For example, if the lasers have spectral distributions that extend to either side of the central wavelength by approximately 5 nanometers, then spacing between the central wavelengths that is greater than 10 nanometers would be desirable. Another factor is the amount of spectral drift present in the lasers. For example, if the lasers have a spectral drift that is ±5 nanometers in wavelength, then the different wavelengths should be separated by at least an amount greater than two times the total spectral drift.

When such a transmitted composite beam is received as an input signal at the transceiver, the transceiver must be capable of differentiating between the different wavelengths in order to advantageously use the increased capacity of the transmitted signal. The various wavelengths included in the transmitted composite signal may be distinguished and separated at the receive terminal by employing Coarse Wavelength Division Multiplexing (CWDM) technology that is well known to those skilled in the art. One or more CWDM filters may be inserted into the optical path of the receive optics, as necessary, to separate the transmitted composite signal into its component wavelengths and directing each wavelength of the transmitted composite signal towards a separate signal receiver. The optional CWDM filter 42 and signal receiver 44 are shown in FIG. 1 for a transceiver using two wavelength communication channels. Alternatively, Dense Wavelength Division Multiplexing (DWDM) may be used in combination with appropriate laser transmitters, such as stabilized DFB lasers.

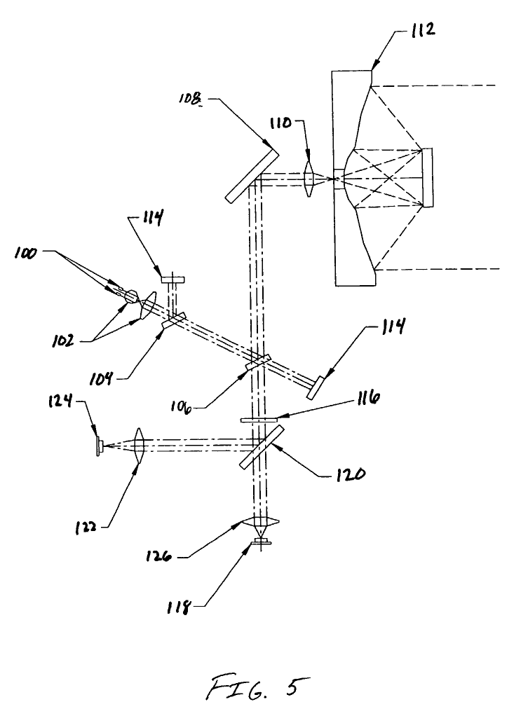

FIG. 5 illustrates the optical paths of a transceiver having a single aperture through which both the incoming and outgoing communication signals pass. In this embodiment of the transceiver, the outgoing communication signal is generated as a composite beam having a first wavelength by fiber coupled light sources 100. The composite beam is collimated by a series of lenses 102 and passed through a narrowband filter 104 to limit the spectral distribution included in the outgoing communication signal. The optical path of the outgoing communication signal is then combined with the optical path of the incoming communication signal at a dichroic filter 106, which directs the outgoing communication signal towards the tilt mirror 108, through a lens 110, and out through the telescope 112. Optical absorbers 114 are included at appropriate positions in the transceiver to absorb the outgoing communication signal where it might stray from the designated optical path. The telescope 112 illustrated in FIG. 5 is a compact telescope as described in U.S. patent application Ser. No. 10/093,865, the disclosure of which is incorporated herein by reference. Other appropriate telescopes known to those skilled in the art may also be used. The telescope 112 forms single aperture of the transceiver.

The incoming communication signal to the transceiver of FIG. 5 enters through the telescope 112. The incoming communication signal is at a second wavelength that is different from the first wavelength of the outgoing communication signal. The incoming communication signal is generated at a remote transceiver similar to the one shown in FIG. 5. However, the remote transceiver transmits its outgoing communication signal at the second wavelength and receives an incoming communication signal at the first wavelength. Thus, two transceivers form a matched pair for free space optical communications.

The telescope 112 directs the incoming signal towards the lens 110, which in turn directs the incoming communication signal towards the tilt mirror 108. The tilt mirror 108 directs the incoming communication signal towards the dichroic filter 106, which allows light at the wavelength of the incoming signal to pass through to a narrowband filter 116 to limit the spectral distribution included in the incoming communication signal that reaches the signal receiver 118. After passing through the narrowband filter 116, the incoming communication signal passes through a beam splitter 120, which directs part of the incoming communication signal towards a focusing lens 122 and an optical position sensor 124. The beam splitter 120 directs the remaining part of the incoming communication signal towards another focusing lens 126 and the signal receiver 118.

When the optical paths of the incoming and outgoing communication signals are combined, such as they are in the single aperture transceiver of FIG. 5, it is important to reduce the amount of interference caused in each communication signal by the other signal. Such interference may arise from sources such as a wide spectral signal, spectral drift in the signal, or stray reflections from within and without the transceiver. It is estimated that the amount of cross interference between the two signals should be less than 80 dB. This isolation requirement may increase or decrease due to factors such as the data rates used in the transmitted signals, the power of the transmitted signals, and the sensitivity of photo receptors used to receive the incoming communication signal. The optical absorbers 114 are strategically positioned within the transceiver to help reduce stray reflections, thereby helping to reduce cross interference. Additionally, the respective wavelengths of the incoming and outgoing communication signals are preferably separated by approximately 35 nanometers for Fabry-Perot laser sources. Greater signal separation may be required depending upon the conditions under which the transceiver is operated. Additionally, greater or lesser separation may be required for different laser sources depending upon the width of the spectrum and/or the amount of spectral drift present.

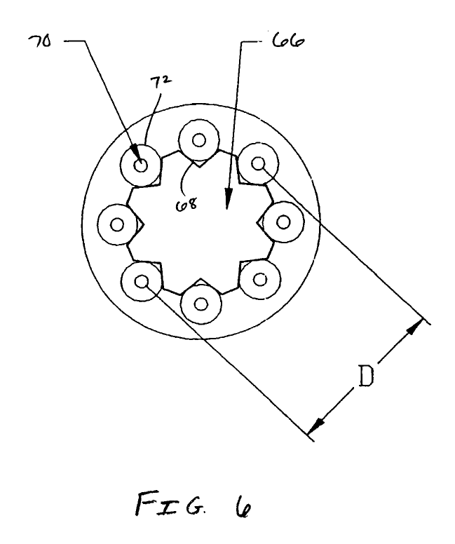

FIG. 6 illustrates an alternative embodiment of a fiber ferrule 66. The ferrule 66 includes a plurality of v-shaped grooves 68 around its outer perimeter. The grooves 66 are identically shaped and cut so that beams emerging from the fibers secured within the grooves are equidistant from the optical axis of the composite beam. If fibers having differing diameters are used, the shape and cut of the grooves in the ferrule should be such that the distance, D, between the optical axes of opposing fiber cores is approximately equal.

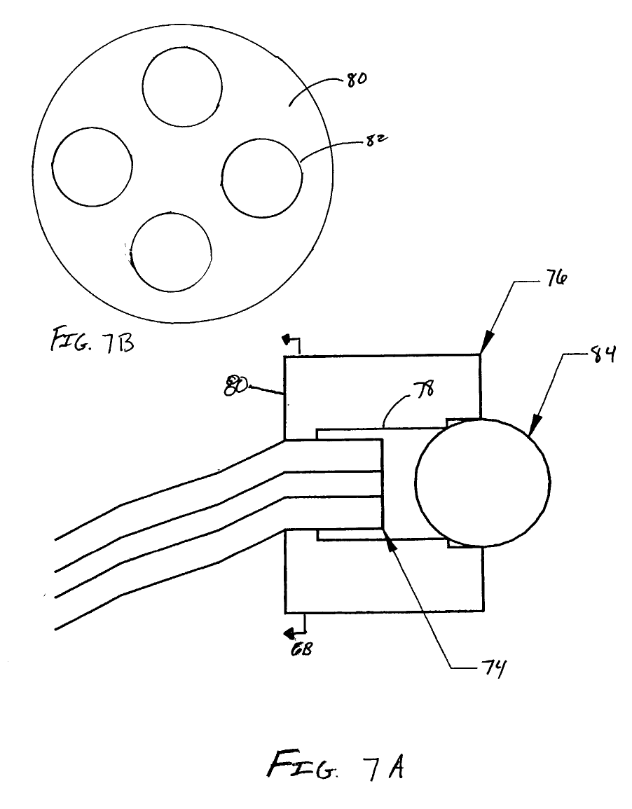

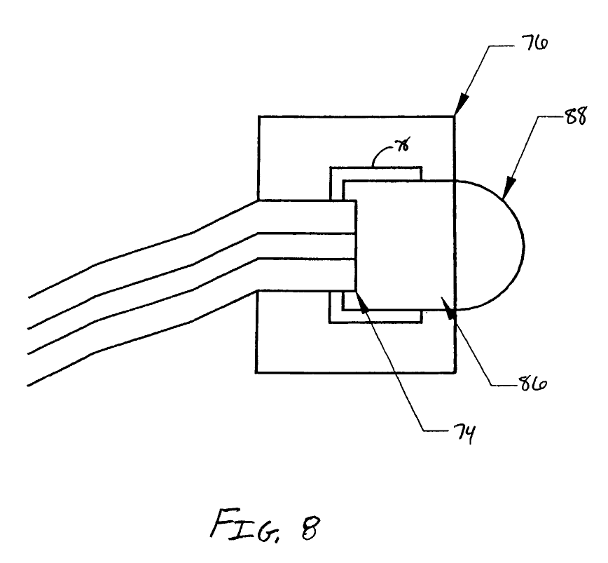

FIGS. 7A and 8 illustrate fiber collimators that may be used to form the composite beam. These fiber collimators include integrated collimating lenses and secure the fibers so that beams emerging from the fiber cores are equidistant from the optical axis of the composite beam. In FIG. 7A, the fibers 74 are secured to a collimator housing 76. A cylindrical bore 78 extends through part of the collimator housing 76, with one side 80 of the collimator housing remaining enclosed. The enclosed side 80 of the collimator housing 76 includes holes 82, the holes 82 aligned as shown in FIG. 7B, through which the fibers are passed. The fibers 74 are secured to the holes 82 and extend through the housing 76 into the cylindrical bore 78. With the fibers 74 thusly secured, beams emerging from the fiber cores are equidistant from the optical axis of the composite beam. A ball lens 84 is disposed in the open end of the cylindrical bore 78. The ball lens 84 collimates the composite beam, which may be relayed to the transmit optics of an optical transceiver.

In FIG. 8, the fibers 74 are similarly secured to a collimator housing 76. Fused silica 86 is disposed within the cylindrical bore 78 and directly optically coupled to the ends of the fibers 74. The fused silica 86 helps protect the ends of the fibers 74 from particulate matter that may be present in the environment. A hemisphere lens 88 is optically coupled to the fused silica 86. Thus, parallel beams emerging from the fibers form the composite beam and the composite beam passes through the fused silica 86. The hemisphere lens 88 collimates the composite beam, which may be relayed to the transmit optics of an optical transceiver.

Thus, an improved optical transceiver for free space communications is disclosed. While embodiments of this invention have been shown and described, it would be apparent to those skilled in the art that many more modifications are possible without departing from the inventive concepts herein. The invention, therefore, is not to be restricted except in the spirit of the following claims.

What is claimed is:

1. An optical transceiver comprising:
a signal transmitter emitting an outgoing communication signal;
transmit optics including a transmit telescope;
receive optics including a receive telescope to receive an incoming communication signal;
a signal receiver; and
a dual-axis tilt mirror positioned to optically couple the signal transmitter to the transmit optics and to optically couple the receive optics to the signal receiver such that the outgoing communication signal is transmitted through the transmit telescope and the incoming communication signal is received through the signal receiver.
